(19) United States
(12) Patent Application Publication
(10) Pub. No.: US 2012/0162453 A1
(43) Pub. Date: Jun. 28, 2012

(54) IMAGE PICKUP APPARATUS

(75) Inventors: Kazuaki Murayama, Hachioji-shi (JP); Hisashi Goto, Suginami-ku (JP); Kengo Enomoto, Tachikawa-shi (JP); Kazuya Yamanaka, Hachioji-shi (JP)

(73) Assignee: OLYMPUS CORPORATION, Tokyo (JP)

(21) Appl. No.: 13/334,336

(22) Filed: Dec. 22, 2011

(30) Foreign Application Priority Data
Dec. 22, 2010 (JP) 2010-285934

(51) Int. Cl. H04N 5/225

(52) U.S. Cl. 348/208.4; 348/335; 348/E05.024

(57) ABSTRACT

An apparatus comprises a taking lens unit, a stop provided between a plurality of optical elements in the taking lens unit, a synchronizing signal generator to which a trigger signal input and that outputs at least a first synchronizing signal and a second synchronizing signal based on the trigger signal, an image pickup unit that performs a first image picking-up based on the first synchronizing signal and performs a second image picking-up based on the second synchronizing signal, and a lens shifting unit that shifts a specific optical element, which is at least one of the optical elements located between the stop and the image pickup unit, in such a way that the center axis of the specific optical element is shifted in a direction perpendicular to the optical axis of the stop during a period after the first image picking-up and before the second image picking-up.

### CROSS-REFERENCE TO RELATED APPLICATION

The present application is based upon and claims the benefit of priority from the prior Japanese Patent Application No. 2010-285934 filed on Dec. 22, 2010; the entire contents of which are incorporated herein by reference.

### BACKGROUND OF THE INVENTION

1. Field of the Invention

The present invention relates to an image pickup apparatus.

2. Description of the Related Art

There have been developed an image pickup apparatus for obtaining a stereoscopic image. The image pickup apparatus has two taking optical systems arranged side-by-side along the horizontal direction of the image pickup apparatus (e.g. digital camera body), on which light from an object enters simultaneously, and two CCD sensors provided respectively for the two taking optical systems to convert optical images formed by the respective taking optical systems into image signals. This image pickup apparatus obtains and reproduces a stereoscopic image using the difference (or parallax) between the two images thus obtained.

In a prior art image pickup apparatus, at least one lens provided in a taking optical system is shifted to obtain parallax images using the one taking optical system in a time sharing manner.

For instance, Japanese Patent Application Laid-Open No. 2005-323065 describes a digital camera that shifts at least one of the plurality of lenses arranged on the optical axis in the horizontal direction perpendicular to the optical axis to obtain images with horizontal parallax.

In the electronic camera described in Japanese Patent Application Laid-Open No. 2010-41381, as with Japanese Patent Application Laid-Open No. 2005-323065, at least one of a plurality of lenses arranged on the optical axis is shifted in the horizontal direction perpendicular to the optical axis to obtain images with horizontal parallax.

### SUMMARY OF THE INVENTION

An image pickup apparatus according to the present invention comprises a taking lens unit including a plurality of optical elements, a stop provided between the plurality of optical elements in the taking lens unit, a synchronizing signal generator to which a trigger signal is input and that outputs at least a first synchronizing signal and a second synchronizing signal based on the trigger signal, an image pickup unit that performs a first image picking-up based on the first synchronizing signal and performs a second image picking-up based on the second synchronizing signal, and a lens shifting unit that shifts a specific optical element, which is at least one of the optical elements located between the stop and the image pickup unit, in such a way that the center axis of the specific optical element is shifted in a direction perpendicular to the optical axis of the stop during a period after the first image picking-up and before the second image picking-up.

### BRIEF DESCRIPTION OF THE DRAWINGS

FIGS. 1A, 1B, and 1C are top views showing the scheme of a digital camera according to a first embodiment;

FIG. 2 is a block diagram of the digital camera according to the first embodiment;

FIG. 3 is a schematic diagram for illustrating the Scheimpflug principle;

FIG. 4 shows a vertical synchronizing signal and the state of an image pickup element in relation to each other;

FIGS. 5A and 5B are top views showing the scheme of a digital camera according to example 1;

FIG. 6 is a block diagram of a digital camera according to a second embodiment;

FIG. 7 is a front view of the digital camera according to the second embodiment in the horizontal orientation; and

FIG. 8 is a front view of the digital camera according to the second embodiment in the vertical orientation.

### DETAILED DESCRIPTION OF THE INVENTION

In the following, embodiments of the image pickup apparatus according to the present invention will be described in detail with reference to the accompanying drawings. should be understood that the present invention is not limited by the embodiments.

The image pickup apparatus according to the present invention has a taking optical system having a plurality of optical systems, in which at least one optical element (which will be referred to as the specific optical element hereinafter) among the optical elements that are disposed closer to the image pickup element than the aperture stop is shifted in a plane perpendicular to the optical axis of the aperture stop to allow the image plane of the image formed by the taking optical system.

More specifically, as a lens is shifted in one direction, an image with an inclined image plane can be obtained, and as this lens is shifted in the opposite direction, an image with an image plane inclined in the opposite direction can be obtained. A stereoscopic image can be obtained by superimposing the two images thus obtained.

According to the image pickup apparatus according to the present invention, a stereoscopic image can be obtained from two images having no particular parallax without need for special image processing. Therefore, a stereoscopic image having a substantial three-dimensional appearance can be obtained even using a small-size image pickup element. Moreover, in the image pickup apparatus according to the present invention, a method utilizing lens shift and a method utilizing parallax can be adopted in combination.

### First Embodiment

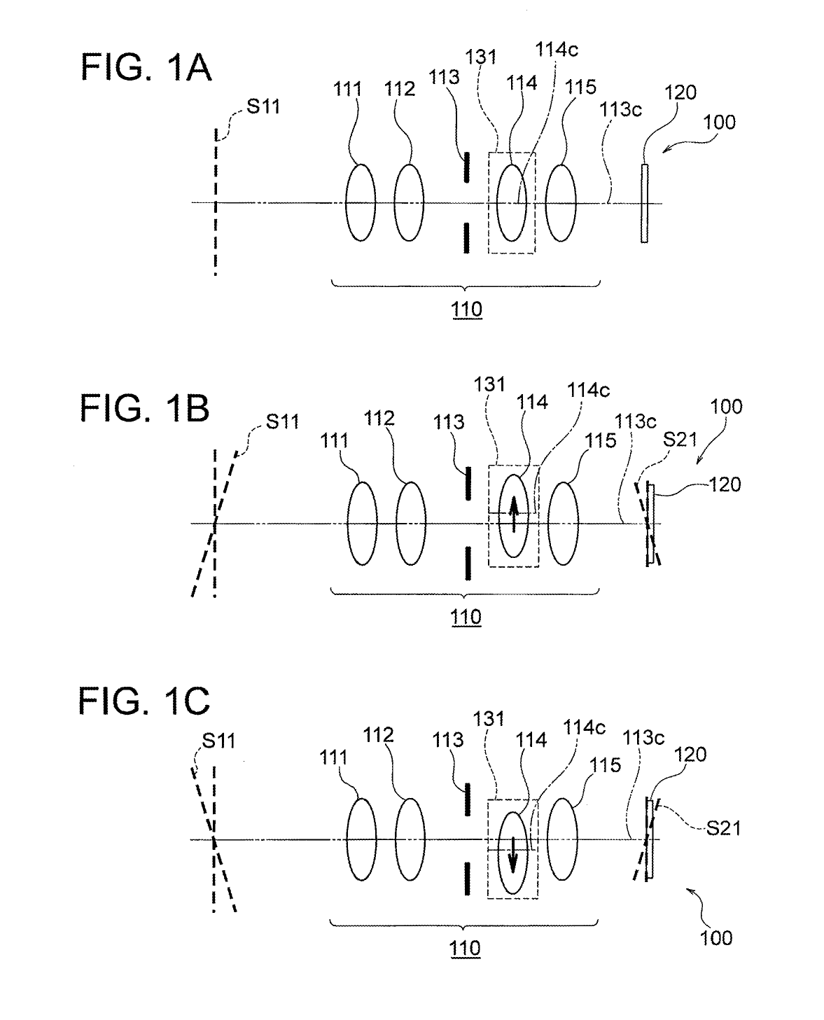

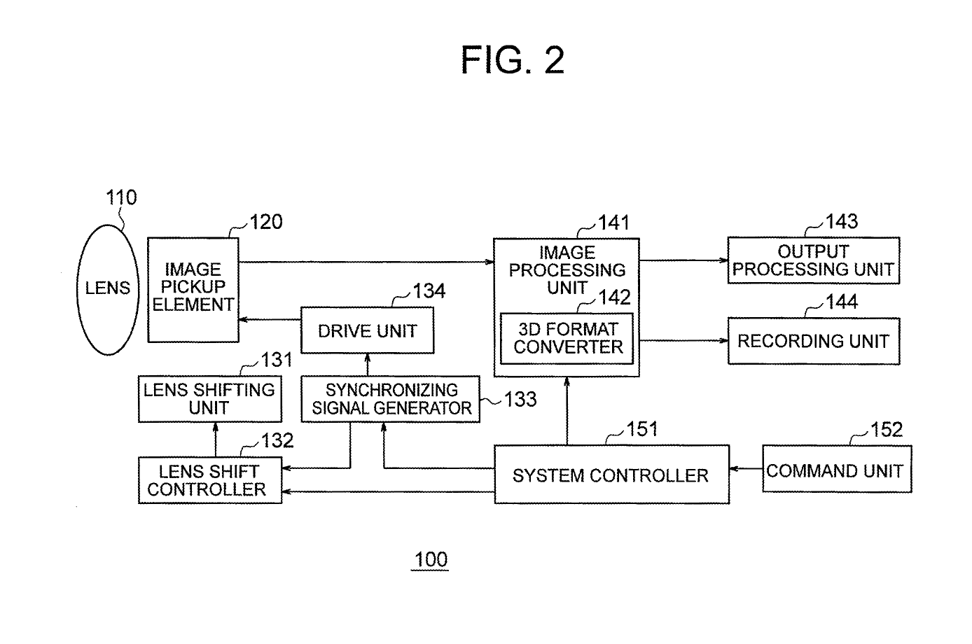

FIGS. 1A, 1B, and 1C are top views illustrating the scheme of a digital camera according to a first embodiment. FIG. 2 is a block diagram of the digital camera according to the first embodiment.

The digital camera (image pickup apparatus) 100 has a taking lens unit 110 and a lens shifting unit 131, an image pickup element 120, and a system controller 151.

The taking lens unit 110 has a plurality of optical elements including lenses 111 and 112, a stop 113, and lenses 114 and 115, which are arranged in order from the object side.

The lens shifting unit 131 is capable of shifting the lens 114 (which is the aforementioned specific optical element) located between the stop 113 and the image pickup element 120 in directions perpendicular to the optical axis 113c of the aperture stop 113. As the lens 114 is shifted, its optical axis 114c shifts onto a line parallel to the optical axis 113c of the stop 113. The lens 114 is shifted in this way in two directions, and an image is picked up each time the lens is shifted. Thus, a pair of images without parallax containing depth information can be obtained.

In the normal state shown in FIG. 1A, the optical axis 114c of the lens 114 is in alignment with the optical axis 113c of the stop 113, and the object plane S11 and the image pickup surface of the image pickup element 120 is perpendicular to the optical axis 113c.

As the lens 114 is shifted in a plane perpendicular to the optical axis 113c of the stop 113 as shown in FIG. 1B, the object plane S11 is inclined in such a way that it is made closer to the taking lens unit 110 in its right side (i.e. the upper side in FIGS. 1A, 1B, and 1C) and farther from the taking lens unit 110 in its left side (i.e. the lower side in FIGS. 1A, 1B, and 1C). In this state, the image plane S21 is inclined in such a way that it is made closer to the taking lens unit 110 in its right side and farther from the taking lens unit 110 in its left side. When the image plane S21 is inclined relative to the image pickup surface 120 in this way, an image in which object points having positional differences with respect to the depth direction are in focus on the image pickup element 120 can be obtained. In consequence, a first image having depth information can be obtained.

As the lens 114 is shifted relative to the optical axis 113c of the stop 113 in the direction opposite to the direction of shift in FIG. 1B in the plane perpendicular to the optical axis 113c of the stop 113, the object plane S11 is inclined in such a way that it is made closer to the taking lens unit 110 in its left side and farther from the taking lens unit 110 in its right side. In this state, the image plane S21 is inclined in such a way that it is made closer to the taking lens unit 110 in its left side and farther from the taking lens unit 110 in its right side. When the image plane S21 is inclined in this way, an image in which object points having positional differences with respect to the depth direction are in focus on the image pickup element 120 can be obtained. Thus, a second image is obtained.

The digital camera 100 picks up the first image as a right eve image while shifting the lens 114 in such a way that the object plane S11 is inclined to run from near right to far left as shown in FIG. 1B and picks up the second image as a left image while shifting the lens 114 in such a way that the object plane S11 is inclined to run from near left to far right. The digital camera 100 obtains a stereoscopic image from the pair of images thus obtained.

The first image and the second image are obtained as tilted image (field tilted image) picked up at different viewpoints.

When outputting or reproducing an image, a stereoscopic (3D) image can be created by outputting the first image and the second image in pair simultaneously.

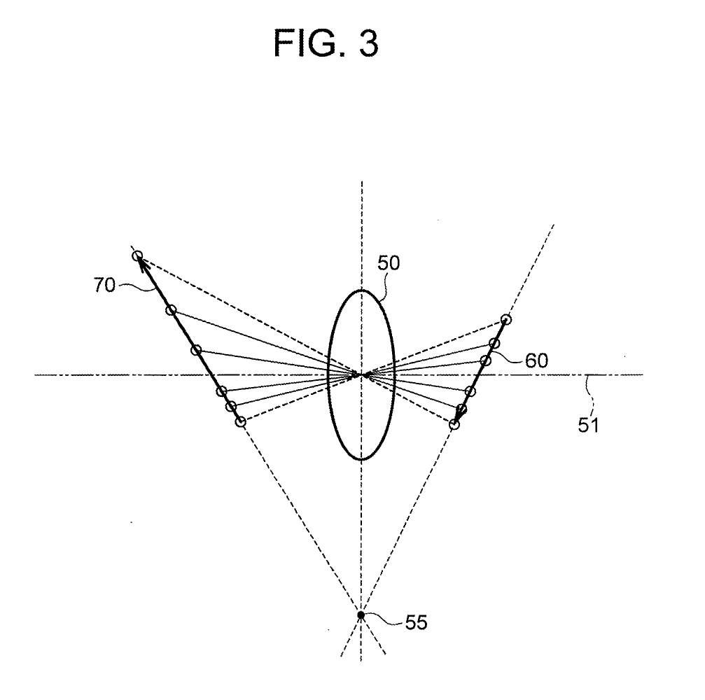

The above-described inclination of the object plane S11 follows the Scheimpflug principle. FIG. 3 is a schematic diagram for illustrating the Scheimpflug principle.

When the image pickup surface and the principal plane of the lens are not parallel to each other, the object plane is not parallel to the principal plane of the lens, and the image plane, the principal plane of the lens, and the object plane intersect on the same single line (represented by intersection point 55 in FIG. 3).

When the image pickup surface 60 of the image pickup element is oriented perpendicular to the optical axis 51 of the taking lens 50, the object plane 70 also lies perpendicular to the optical axis 51. On the other hand, when the image pickup surface 60 is inclined in an angle other than 90 degrees as illustrated in FIG. 3, the object plane 70 is inclined or tilted correspondingly to the inclination of the image pickup surface 60 according to the Scheimpflug principle. In addition, if the angle of the image pickup surface 60 is changed, the magnification of the image plane in the height direction varies with respect to the optical axis 51.

According to the above-described principle, an image in which object points at different distances are in focus can be obtained irrespective of whether there is a parallax or not. Therefore, a stereoscopic image can be created.

The operation and control of the digital camera 100 will be described in more detail with reference to FIG. 2.

As shown in FIG. 2, the digital camera 100 is provided with the taking lens unit 110, the image pickup element 120, the image pickup element shifting unit 131, a lens sift controller 132, a synchronizing signal generator 133, a drive unit 134, an image processing unit 141, an output processing unit 143, a recording unit 144, a system controller 151, and a command section 152.

The digital camera 100 according to the first embodiment can widely be applied to various apparatuses having the function of motion picture display and the function of motion picture taking, such as digital cameras, digital video cameras, surveillance cameras, and cellular phones having a picture taking function.

The taking lens unit 110 is a taking optical system for forming an optical image of an object on the image pickup surface 121 of the image pickup element 120. The taking lens unit has a plurality of optical elements including the lenses 111, 112, the stop 113, and the lenses 114, 115, which are arranged in order from the object side.

The image pickup element 120 has the image pickup surface on which a plurality of pixels are arranged to photoelectrically convert an optical image of an object formed by the taking lens unit 110 into an electrical image signal. The image pickup element 120 is capable of performing, at desired timing, pixel resetting (electrical leading shutter curtain) and image reading (electrical trailing shutter curtain) sequentially on a pixel by pixel basis or line by line basis. In other words, the image pickup element 120 is capable of varying the exposure time. The image pickup element 120 may be, but not limited to, an XY address image pickup element such as a CMOS image pickup element.

The synchronizing signal generator 133 is controlled by the system controller 151 to generate a vertical synchronizing signal VD that provides a basis for the timing of driving of the image pickup element 120.

In the case where there is a vertical synchronization period (corresponding to the image pickup frame rate) determined based on an input from the command section 152, the system controller 151 outputs a trigger signal to the synchronizing signal generator 133 and sets the vertical synchronization period in the synchronizing signal generator 133.

On the other hand, in the case where there is not a vertical synchronization period determined based on an input from the command section 152, the system controller 151 sets a predetermined vertical synchronization period in the synchronizing signal generator 133. The predetermined vertical synchronization period may be, for example, a vertical synchronization period corresponding to an image pickup frame rate given as a standard value or a vertical synchronization period corresponding to the image pickup frame rate currently used in driving the image pickup element 120.

The system controller 151 controls the synchronizing signal generator 133 so that the synchronizing signal generator 133 generates a vertical synchronizing signal VD with the vertical synchronization period set in the synchronizing signal generator 133 in this way.

The drive unit 134 is controlled by the system controller 151 to generate a read start pulse and an electronic shutter start pulse at timing determined based on the vertical synchronizing signal VD generated by the synchronizing signal generator 133, thereby driving the image pickup element 120.

The lens shift controller 132 is controlled by the system controller 151 to control the shifting of the lens 114 in the taking lens unit 110 at timing determined based on the vertical synchronizing signal VD generated by the synchronizing signal generator 133. Specifically, the lens shift controller 132 controls the shifting of the lens 114 in such a way that the shifting operation is completed during the blanking interval of the vertical synchronizing signal VD. The system controller 151 selects the direction and amount shift of the lens 114 and the shooting pattern according to the 3D mode determined based on an input from the command section 152 to control the lens shift.

The lens shifting unit 131 shifts the lens 114 in accordance with a control command from the lens shift controller 132. The shifting may be performed using, for example, a voice coil motor (VCM), a stepping motor, or an ultrasonic motor.

The image processing unit 141 applies various image processing to image signals picked up by and read out from the image pickup element 120. The image processing unit 141 includes the 3D format converter 142. When a 3D mode is selected by the command section 152, the 3D mode is set in the 3D format converter 142 by the system controller 151. The 3D format converter 142 performs 3D mode conversion according to the mode thus set. Examples of the 3D mode conversion include SIDE-BY-SIDE, LINE-BY-LINE, ABOVE-BELOW, and CHECKERBOARD.

The output processing unit 143 outputs an image processed by the image processing unit 141 for display (including an image after 3D format conversion) to an external display apparatus such as a TV set. In addition, the output processing unit 143 also outputs an image to a display device for displaying the operation menu of the digital camera 100 etc.

The recording unit 144 stores, in a nonvolatile manner, image data processed by the image processing section 141 for recording. The recording unit 144 may be, for example, a removable memory, such as a memory card, that can be taken out from the digital camera 100. Therefore, the recording unit 144 may not necessarily be a component belonging to the digital camera 100.

The command section 152 is a user interface used to make operational entries to the digital camera 100. The command section 152 includes a power button for turning on/off the power, an image taking button for starting image taking, an image taking mode setting button for setting the 3D mode etc, and other various setting buttons.

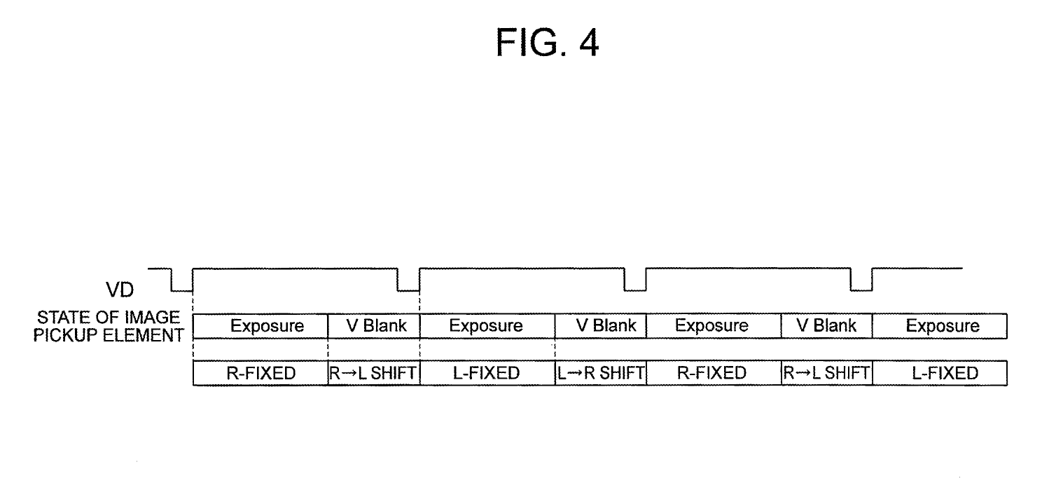

In the following, how the lens is shifted will be described in detail with reference to FIG. 4. FIG. 4 shows the vertical synchronizing signal and the state of the image pickup element in relation to each other.

FIG. 4 shows the vertical synchronizing signal VD of the image pickup element, the exposure period “EXPOSURE” of the image pickup element, the vertical blanking interval “V BLANK” of the image pickup element, the state “R-FIXED” in which a right image is picked up in the 3D image pickup mode, and the state “L-FIXED” in which a left image is picked up in the 3D image pickup mode, in relation to time that progresses in the horizontal direction.

When the digital camera 100 is set to the 3D mode, the lens 114 is shifted during vertical blanking intervals of the image pickup element 120 based on the vertical synchronizing signal VD of the image pickup element 120 to allow picking up of a left or right image. On the other hand, during the exposure of the image pickup element 120, the taking lens unit 110 is fixed in the shifted state. The above-described shifting operation is performed repeatedly to pick up right and left images alternately.

The relationship between the shift of the lens 114 and the inclination of the object plane S11 and the image plane S21 also applies to the case in which a plurality of lenses located between the stop 113 and the image pickup element 120 are shifted.

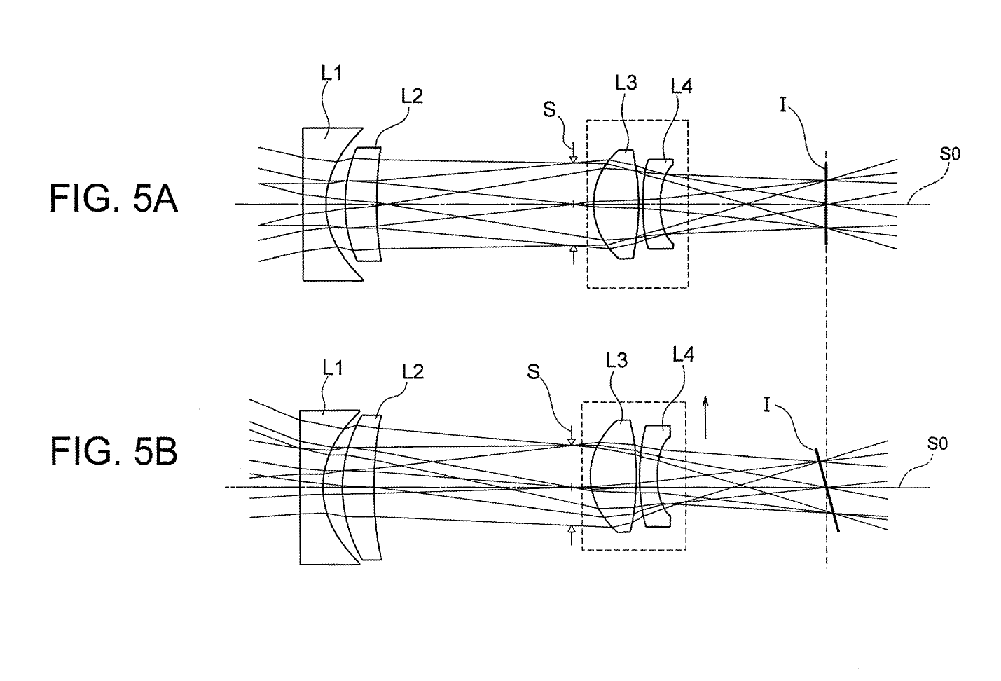

FIGS. 5A and 5B are top views showing the scheme of the digital camera according to an example 1 of the first embodiment. The digital camera according to the example 1 has a lens L1, a lens L2, a stop S, a lens L3, and a lens L4 that are arranged in order from the object side. Two lenses L3 and 14 are specific optical elements that can be shifted in a plane perpendicular to the optical axis S0 of the stop S.

In the state in which the lenses L3 and L4 are not shifted as shown in FIG. 5A, the image plane I is perpendicular to the optical axis S0 of the stop S. As the lenses L3 and L4 are shifted as shown in FIG. 5B, the image plane I is inclined with respect to the optical axis S0 of the stop S correspondingly to the direction of the shift. If, though not shown, the lenses L3 and L4 are shifted in the direction opposite to the direction of shift shown in FIG. 5B in a plane perpendicular to the optical axis S0 of the stop S, the image plane I is inclined relative to the optical axis S0 of the stop S correspondingly to the direction of the shift. Thus, images are picked up in the states in which the lenses L3 and L4 are shifted in the opposite directions respectively. A stereoscopic image can be created from these images.

### Second Embodiment

A digital camera (image pickup apparatus) 200 according to a second embodiment differs from the digital camera 100 according to the first embodiment in that the digital camera 200 has an orientation detector 260 that detects the orientation of the camera. The components same as those in the digital camera 100 according to the first embodiment are denoted by the same reference symbols and will not be described in detail.

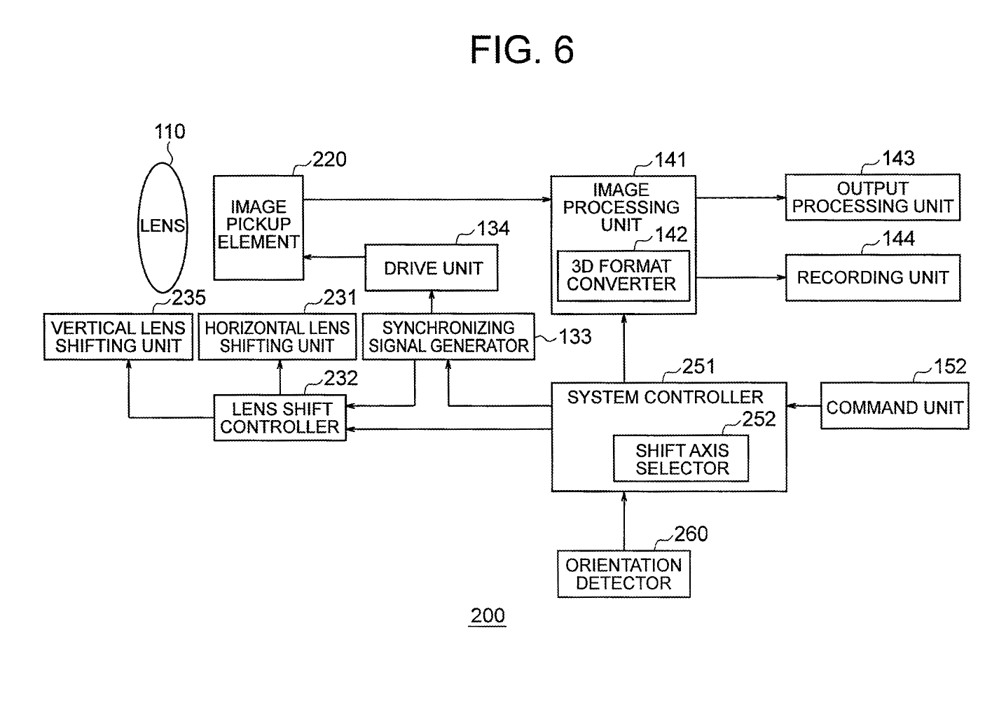

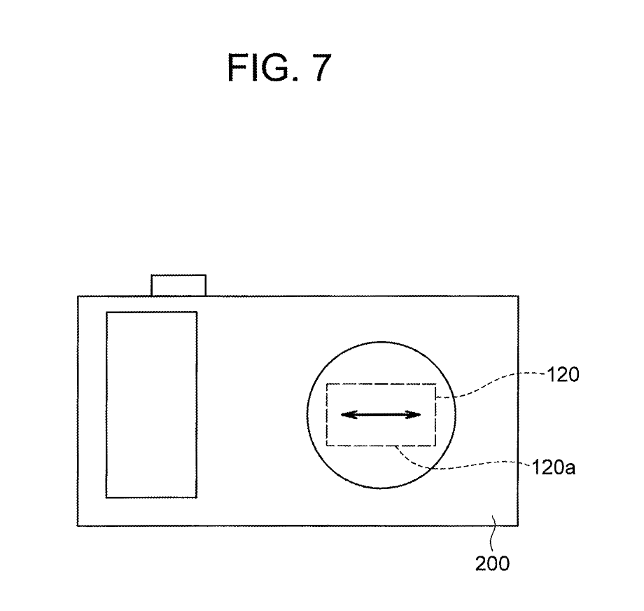

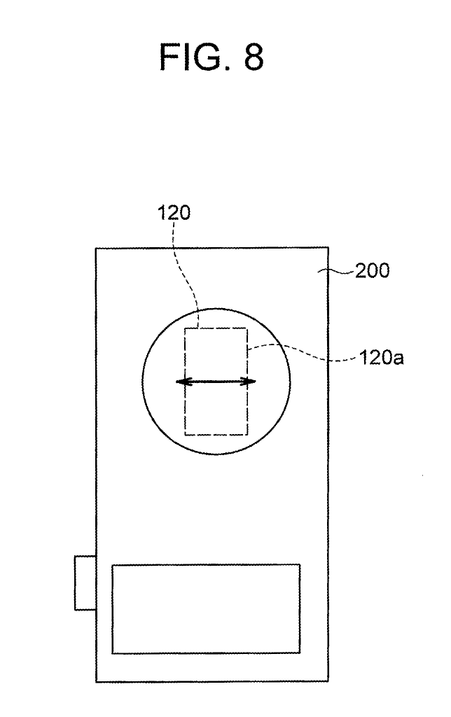

FIG. 6 is a block diagram showing the configuration of the digital camera 200. FIG. 7 is a front view of the digital camera 200 in the horizontal orientation. FIG. 8 is a front view of the digital camera 200 in the vertical orientation.

The digital camera 200 has a horizontal lens shifting unit 231 and a vertical lens shifting unit 235 in place of the lens shifting unit 131 in the first embodiment. The digital camera 200 also has a lens shift controller 232 and a system controller 251 in place of the lens shift controller 132 and the system controller 151. The digital camera 200 further has the orientation detector 260. The system controller 251 includes a shift axis selector 252.

The orientation detector 260 is a sensor that detects whether the digital camera 200 is in the horizontal orientation (as shown in FIG. 7) or in the vertical orientation (as shown in FIG. 8). The orientation detector 260 sends a signal indicative of the result of detection to the shift axis selector 252 in the system controller 251. The orientation detector 260 detects that the digital camera 200 is held in the horizontal orientation in which the longer side 120a of the horizontally long, rectangular image pickup element 120 is oriented horizontally as shown in FIG. 7 and that the digital camera 200 is held in the vertical orientation in which the longer side 120a of the image pickup element 120 is oriented vertically as shown in FIG. 8.

The shift axis selector 252 selects the horizontal or vertical lens shift axis based on the result of detection received from the orientation detector 260 and sets the shift axis for the lens shift controller 232.

when the horizontal orientation is set in accordance with the setting by the shift axis selector 252 (FIG. 7), the lens shift controller 232 actuates the horizontal lens shifting unit 231 to shift the lens 114 in the horizontal direction (the direction indicated by the arrows in FIG. 7. On the other hand, when the vertical orientation is set (FIG. 8), the lens shift controller 232 actuates the vertical lens shifting unit 235 to shift the lens 114 in the vertical direction (the direction indicated by the arrows in FIG. 8).

With the above-described features and the operations, the lens 114 can be shifted in an appropriate direction in accordance with the orientation of the digital camera 200. In consequence, stereoscopic images can be obtained stably.

The features, operations, and effects of the second embodiment other than described above are the same as those in the first embodiment.

A stereoscopic image can be obtained by the following combinations of the ways of image picking-up.

(1) A combination of two ways of image picking-up performed respectively in different states in which the optical axis of the shifted lens is not in alignment with the optical axis of the stop. An example is the combination of the state shown in FIG. 1B and the state shown in FIG. 1C.

(2) A combination of ways of image picking-up performed respectively in the state in which a lens is not shifted and in the state in which the lens is shifted to be offset from the optical axis of the stop. An example is the combination of the state shown in FIG. 1A and the state shown in FIG. 1B or FIG. 1C.

The stereoscopic images obtained will have the following characteristics according to the image pickup method.

(A) In the case of the above method (1), if the two shifted positions of the lens are symmetrical with respect to the optical axis 113c of the stop 113 as is the case in the combination of the state shown in FIG. 1B and the state shown in FIG. 1C, the left and right images will be highly symmetrical.

(B) In the case of the above method (2), both 2D image pickup and 3D image pickup can be performed excellently, because the image pickup surface of the image pickup element 120 is oriented perpendicular to the optical axis 113c in one state as is the case in the state shown in FIG. 1A. Moreover, this method can flexibly be adapted for various 3D expressions.

As described above, the image pickup apparatus according to the present invention is useful for stereoscopic (3D) imaging in a digital camera.

The image pickup apparatus according to the present invention is advantageous in that it can obtain stereoscopic images having a substantial three-dimensional appearance while being small in size.

What is claimed is:

1. An image pickup apparatus comprising:
a taking lens unit including a plurality of optical elements;
a stop provided between the plurality of optical elements in the taking lens unit;
a synchronizing signal generator to which a trigger signal is input and that outputs at least a first synchronizing signal and a second synchronizing signal based on the trigger signal;
an image pickup unit that performs a first image picking-up based on the first synchronizing signal and performs a second image picking-up based on the second synchronizing signal; and
a lens shifting unit that shifts a specific optical element, which is defined to be at least one of the optical elements located between the stop and the image pickup unit, in such away that the center axis of the specific optical element is shifted in a direction perpendicular to the optical axis of the stop during a period after the first image picking-up and before the second image picking-up.

2. The image pickup apparatus according to claim 1, wherein the lens shifting unit shifts the specific optical element in such a way that an image plane formed in the image pickup unit is inclined.

3. The image pickup apparatus according to claim 1, wherein the specific optical element shifted by the lens shifting unit is a blur correction lens that is used to optically correct blur of image formed in the image pickup unit.

4. The image pickup apparatus according to claim 1, wherein the amount of shift of the specific optical element caused by the lens shifting unit can be set arbitrarily.

5. The image pickup apparatus according to claim 1, wherein the lens shifting unit shifts the specific optical element in such a way that the shift of the center axis of the specific image pickup element from the optical axis of the stop for the second image picking up is substantially symmetrical with that for the first image picking-up.

6. The image pickup apparatus according to claim 1, wherein if the center axis of the specific optical element is not aligned with the optical axis of the stop at the time of the first image picking-up, the lens shifting unit shifts the specific optical element in such a way as to bring the center axis in alignment with the optical axis of the stop.

7. The image pickup apparatus according to claim 1, wherein at the time of the first image picking-up, the lens shifting unit shifts the specific optical element in such away that the center axis of the specific optical element is shifted in a direction perpendicular to the optical axis of the stop.

8. The image pickup apparatus according to claim 7, wherein at the time of the first image picking-up, the lens shifting unit shifts the specific optical element in such a way as to bring the center axis of the specific optical element in alignment with the optical axis of the stop.

9. The image pickup apparatus according to claim 1, further comprising a sensor that detects the orientation of the image pickup apparatus, wherein the lens shifting unit shifts the specific optical element based on a result of detection by the sensor.

10. The image pickup apparatus according to claim 1, wherein the lens shifting unit shifts the specific optical element during a blanking interval of the image pickup unit.
